(19) United States
(12) Patent Application Publication
(10) Pub. No.: US 2007/0050389 A1
(43) Pub. Date: Mar. 1, 2007

(54) Advertisement placement based on expressions about topics

(75) Inventors: James Jin Kim, Los Altos, CA (US); Hongcheng Mi, Sunnyvale, CA (US)

Correspondence Address: LUMEN INTELLECTUAL PROPERTY SERVICES, INC., 2345 YALE STREET, 2ND FLOOR, PALO ALTO, CA, 94306, US

(73) Assignee: Opinmind, Inc.

(21) Appl. No.: 11/273,873

(22) Filed: Nov. 14, 2005

Related U.S. Application Data
(60) Provisional application No. 60/713,314, filed on Sep. 1, 2005.

(51) Int. Cl. G06F 7/00

(52) U.S. Cl. 707/101

(57) ABSTRACT

A method for analyzing and organizing expressions about topics (ETs) identified in digitally available content is provided. Expressions about topics could be categorized in at least two distinct groups, such as positive ETs and negative ETs. Each categorized expression-topic set could be ranked within its own group based on a variety of parameters. The method could be used for displaying advertisements on a digitally available page based on expressions about topics. The method could also be used for searching the categorized expression-topic sets for expressions about a topic of interest. The advantage of the method is that it would increase contextual relevance in advertisement placement and search queries.

### CROSS-REFERENCE TO RELATED APPLICATION

This application is cross-referenced to and claims benefit from U.S. Provisional Application 60/713,314 filed Sep. 1, 2005, which is hereby incorporated by reference.

### FIELD OF THE INVENTION

The invention relates generally to analyzing and organizing digitally available content. More particularly, the invention relates to analyzing and organizing digitally available content for advertisement placement on a digitally available page.

### BACKGROUND OF THE INVENTION

Advertisement placement in online content is a fast growing segment in today's economy. Presently, placement of online advertisements is based on sophisticated techniques such as described in Google's U.S. Patent Applications 2004/0059708 and 2005/0114198. Using these techniques, an advertiser could bid on keywords that relate to their product or service, and link these keywords to an advertisement. When these keywords appear on a particular website, Google's method delivers the advertisement to that website.

Despite the sophistication of present methods, a common problem is still the lack of contextual relevancy of the advertisement relative to the content. For example, an advertiser such as McDonald's could subscribe to the keyword “hamburger”. The McDonald's advertisement might then appear on websites with a high appearance or count of the keyword “hamburger”. While seemingly contextually relevant to the keyword “hamburger”, it would be problematic if the content on the webpage describes that hamburgers could actually be harmful to your health. Evidently, the contextual relevance of keyword-based advertisement placement is limited and leaves room for ambiguous interpretation.

Accordingly, it would be considered an advance in the art to provide new methods that would reduce the ambiguity and increase the likelihood that an advertisement is placed appropriately and matches the content of a webpage. An increase in contextual relevancy of advertisements would then translate into a direct or indirect increase in advertiser brand recognition, product purchases by consumers, and click-through rates to advertisers' websites for general information or product/service purchase.

### SUMMARY OF THE INVENTION

The present invention provides a method for analyzing and organizing expressions about topics (ETs) identified in digitally available content that would increase contextual relevance in advertisement placement and even search queries. Examples of digitally available content that are, e.g. content available in a corpus of weblog pages (blogosphere), in instant messengers, in emails, in periodicals, in magazines, in newspapers, in reviews, in journals or in editorials. Expressions about topics include for example sentiments about topics, opinions about topics, perceptions about topics, feelings about topics, moods about topics, expressions about author's state of mind, or any combination thereof.

Expressions about topics are also referred to as expression-topic sets which could be categorized in at least two distinct groups. One example of a categorization is distinguishing the expression-topic sets into polarized groups such as positive ETs and negative ETs. Each categorized expression-topic set could be ranked within its own group based on a variety of parameters.

In one embodiment, the method could be used for displaying advertisements on a digitally available page based on expressions about topics. One could associate at least one advertisement to at least one of the expression-topic sets selected from the categorized groups. The associated advertisement could be displayed on the digitally available page that contains at least part of associated expression-topic set. An advertiser could also subscribe advertisements to categorized expression-topic sets. An advertiser could also be involved in a competitive bidding process on associated expression-topic sets to determine placement of the associated advertisements on the digitally available page. In the case where there are multiple advertisers, the associated expression-topic sets could be ranked to determine placement of the associated advertisements on the digitally available page.

In another embodiment, the method could be used for searching the categorized expression-topic sets for expressions about a topic of interest. The search results for the topic of interest could then be displayed to a user, preferably organized into at least two distinct groups. One example of displaying the search results is to display positive and negative expressions about the topic of interest. In case the user is an advertiser, the search results could be used as a starting point for associating and subscribing one or more advertisements to one or more expression-topics sets.

### BRIEF DESCRIPTION OF THE DRAWINGS

The objectives and advantages of the invention will be understood by reading the following detailed description in conjunction with the drawings, in which:

FIG. 1 shows an overview of placing advertisements into digitally available content based on expressions about topics according to the present invention.

FIG. 2 shows examples of digitally available content on the Internet containing expressions about topics according to the present invention.

FIG. 3 shows an example of an interface for accessing and searching expression-topic sets whereby the expression-topic sets are organized in two distinct groups according to the present invention.

FIG. 4 shows an example of matching expression-topic subscription sets with content in a blog page according to the present invention.

FIG. 5 shows an example of advertisement placement on a blog page based on an expression-topic subscription set according to the present invention.

FIG. 6 shows an example of ranking advertisements according to the present invention.

### DETAILED DESCRIPTION

1. General Concept

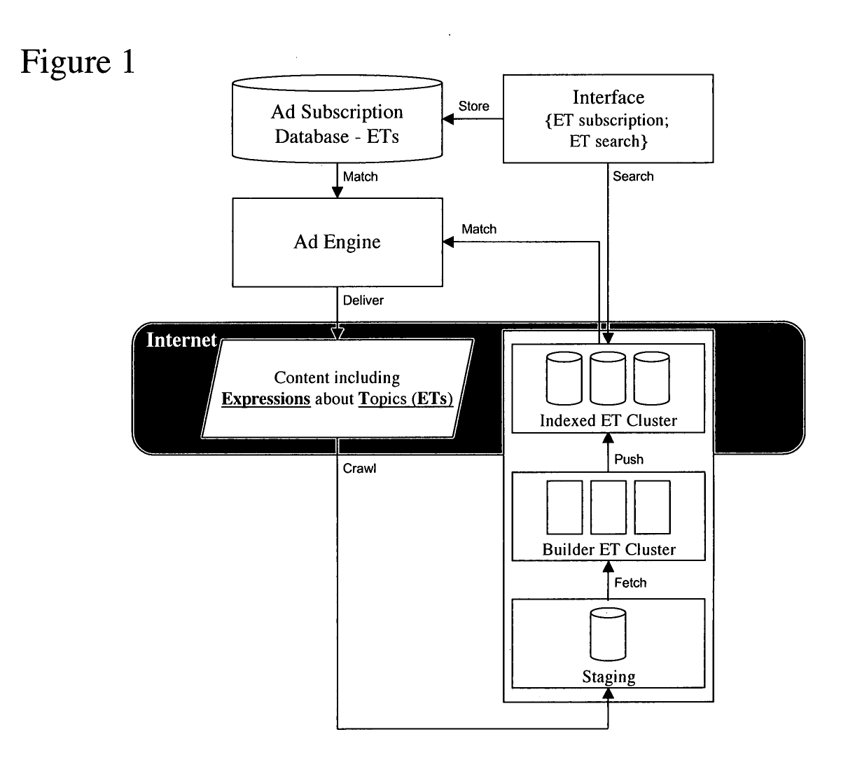

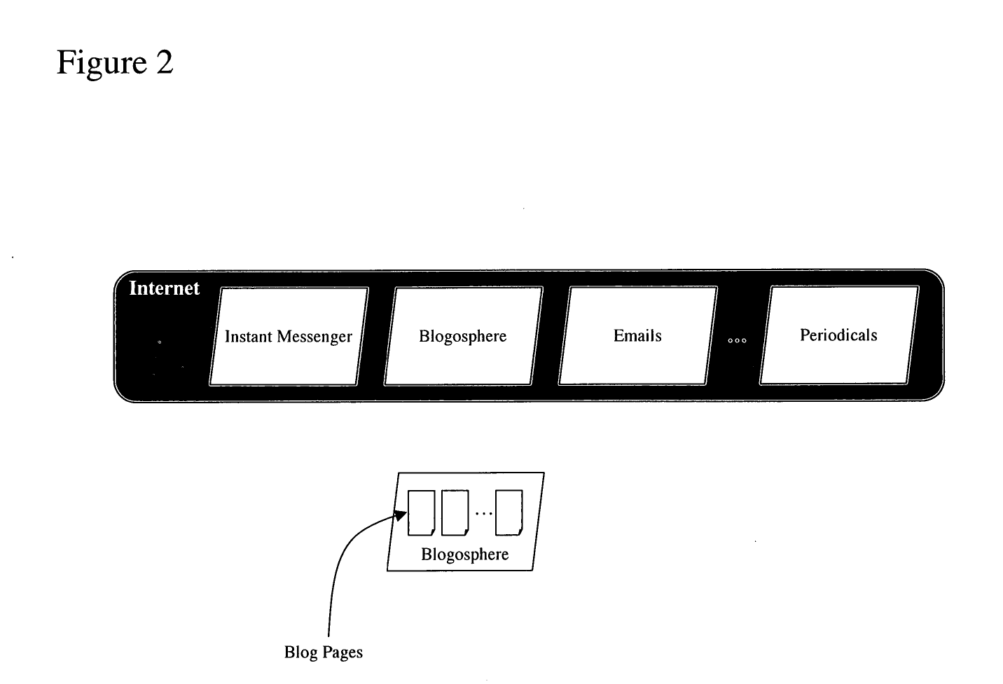

Expressions about topics (ETs) are identified in any type of digitally available content (FIG. 1). In a particular example of the invention, content available in weblogs (“blogs”) is targeted for the identification of ETs. Blogs are a preferred target since they are an ideal place for people to express themselves about topics. However, in general, content from any type of digitally available content could be targeted such as content in Instant Messengers, Emails, Periodicals, or the like (FIG. 2).

Expressions about topics, also referred to herein as “expression-topic sets”, include anything expressed about a topic or related to a topic such as a sentiment, an opinion, a perception, a feeling, a state of a person's mind, or the like, or a combination thereof. It is noted that the expression-topic sets of the present invention are significantly different from keyword-keyword matches.

A web crawler, as known in the art, could be used to find and store digitally available content on the Internet. The URLs could be stored and refreshed at specific time intervals. The crawled information could be stored in temporary staging tables before they are analyzed.

The content pages are analyzed to identify expressions about topics. These expression-topic sets are then categorized into at least two distinct groups. In one example, the categories could be polarized groups such as positive (+) or negative (−) expressions about a topic. The categories could be further refined (or polarized) into three or more groups such as positive (+), neutral (0) and negative (−). Taking into account a more detailed analysis of the expression-topic sets could further refine each category.

It is noted that the categories could be organized and displayed in at least two dimensions. In the example of a two-dimensional organization of the expression-topic sets, the first dimension could have two groups, such as group 1 defined as positive expression-topic sets and group 2 defined as negative expression-topic sets. The second dimension could apply to each group, i.e. group 1 and 2, whereby each expression-topic set in that group is organized or ranked based on a variety of parameters, such as the type of expression about the topic and/or strength of the expression about the topic. Type, strength and any other parameters could be determined by specific analyses applied to the expression-topic sets. Examples of such analyses are provided herein.

Other parameters that could determine ranking of the expression-topic sets in the second dimension are, e.g. (i) the “freshness” of the content page, which could be the latest published date relative to the current date for, e.g., a blog or (ii) a search query match, which determines how closely a user's search query matches to the target found in the sentence.

The categorized information could be indexed and stored in an electronic database and made accessible, preferably, over the Internet to users. Information that could be stored relates to the content of the identified page, the sentence in which the expressions about topics were made, the topic(s) for which the expressions were made, the polarity of the expression-topic sets, a rank score of the expression-topic sets, the URL of the content page, characteristics of the blogger who posted the page, or the like.

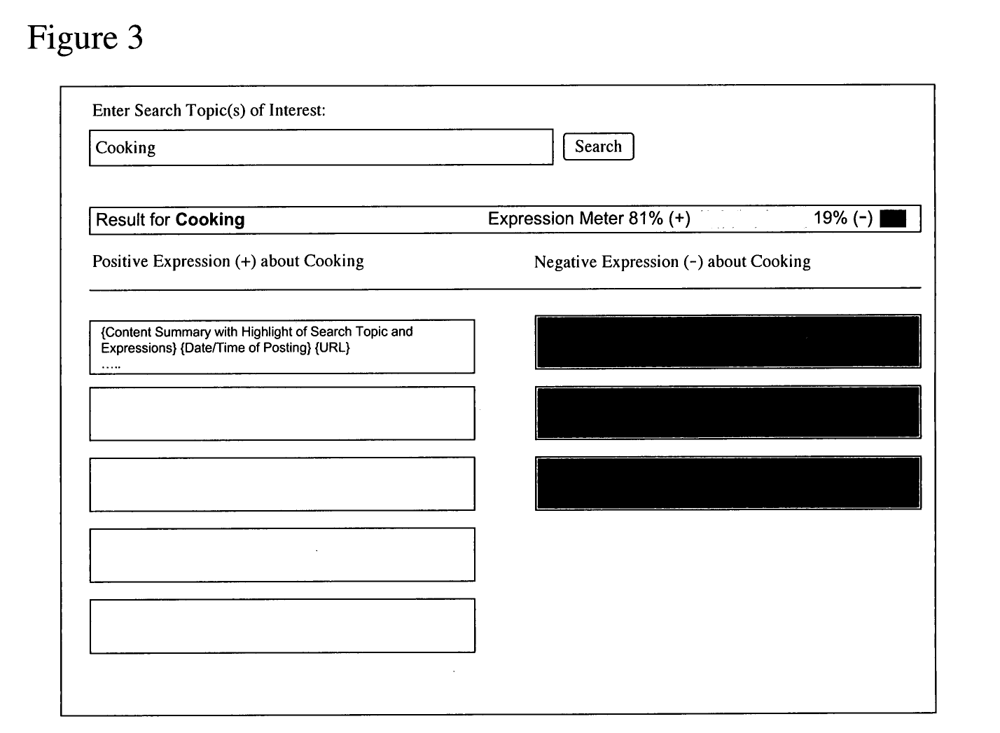

An interface capable of accessing the stored information, again preferably over the Internet, could be used to enable a user to access, search and/or identify one or more categorized expression-topic sets for a topic of their interest. FIG. 3 shows an example of an interface where a user could enter one or more topics for a search request. The search request is then analyzed and returns search results that are organized in two or more distinct groups of expression-topic sets for the search query topic(s), e.g. “cooking”. The example of FIG. 3 shows two categories, i.e. positive expressions about cooking and negative expressions about cooking. Each search result could display information such as content summary, the expression and topic, date/time of the content page, URL of the content page, etc. The results could be organized in any number of categories and are not limited to just two, i.e. positive and negative, as discussed herein earlier. Feedback could be provided to the user about the relevancy or strength as well as the absolute or relative distribution of the expressions for the search topic. In the example of FIG. 3 an expression-meter is added to provide feedback about the relative distribution of the search topic “cooking” over two categories, positive and negative expressions for cooking.

One could also enter a search query such as “cooking+”. Here the user is interested in learning about positive expression-topic sets about the topic “cooking”. In this case the search query for “cooking+”, the display or feedback to the user could be in just one category or in at least one distinct category. FIG. 3 could then be simplified into one category of search results. Furthermore, one could enter a search query with a combination of expressions for a search topic, such as “cooking+, cooking++. This could mean positive (+) expressions about “cooking” and very positive expression (++) about “cooking”. As a person of average skill in the art would readily appreciate, any type of search query combining one or more expressions for a topic of interest could be made.

With this interface an advertiser could identify one or more categorized expression-topic sets and associate one or more of their advertisements with these categorized expression-topic sets. The advertiser could then further subscribe to these particular expression-topic sets for their advertisement(s). An example of a subscription could involve two distinct expressions related to the topic “cooking”. Expressions for this topic could be categorized like:
(i) “cooking” described in a positive sense, such as “Cooking is fun” or “I love cooking”. This category could be indexed as (cooking)+.
(ii) “cooking” described in a negative sense, such as “Cooking is such a pain!” or “I hate cooking”. This category could be indexed as (cooking)−.

An advertiser like www.cookingrecipes.com would be able to subscribe to an advertisement placement on Websites in which cooking is described positively, i.e. www.cookingrecipes.com would be able to subscribe to the category (cooking)+. On the other hand, an advertiser like www.tvdinners.com would be able to subscribe to an advertisement placement on Websites in which cooking is referred to negatively, i.e. www.tvdinners.com would be able to subscribe to category (cooking)−.

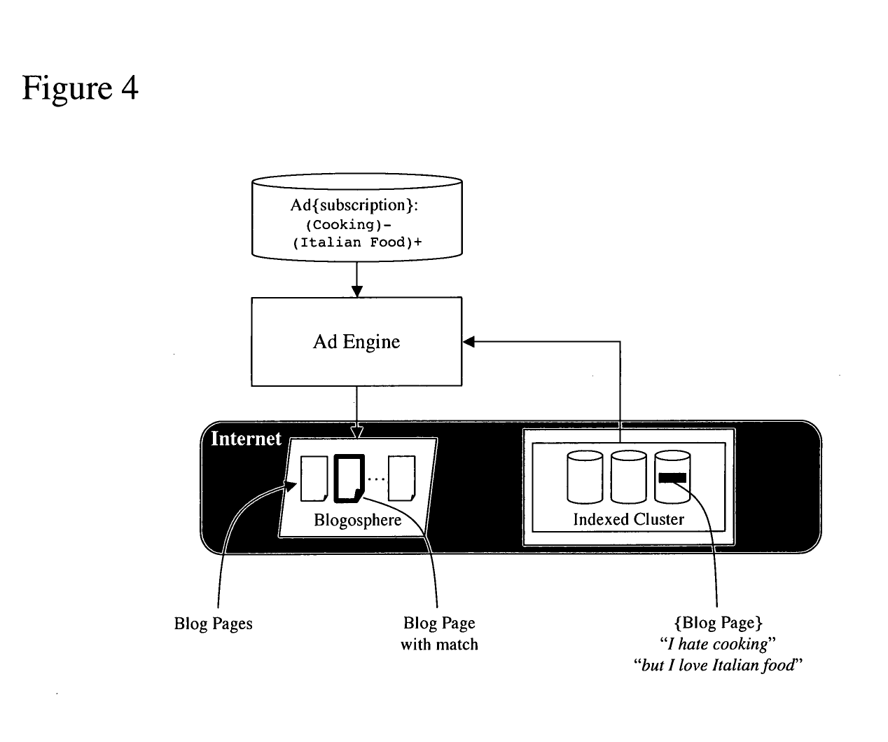

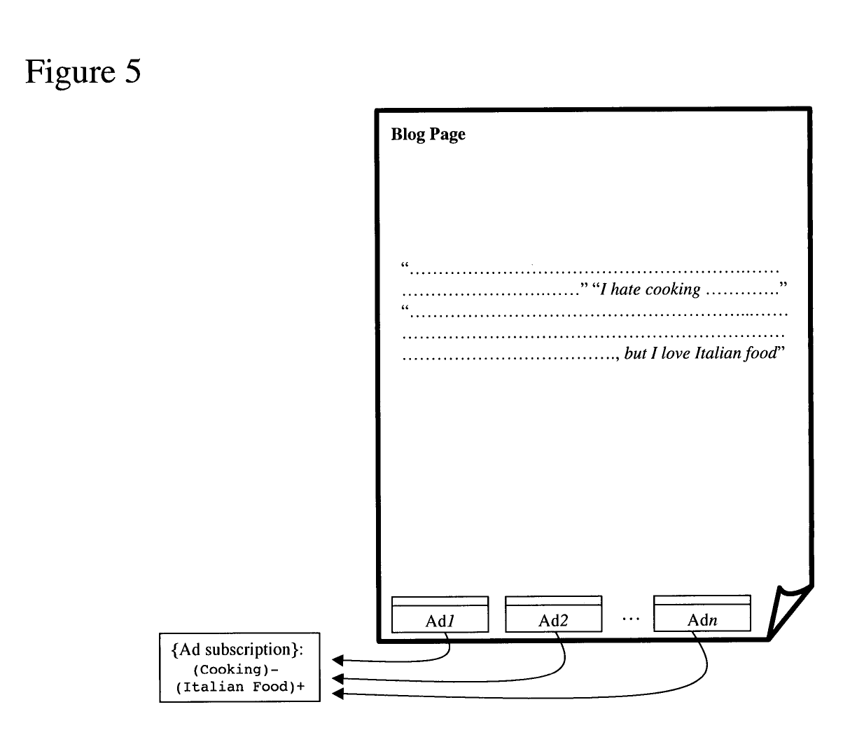

Subscription information for each advertiser could be stored in an advertisement (Ad) subscription database. A semantic analysis engine analyzes a target content page (e.g. a Blog Page) and stores the ET and unique identifier information (e.g. URL, time/date of blog entry, or any other related information) in an indexed database. For each subscription in the subscription database, an advertisement (Ad) engine matches advertiser subscriptions with ET's that are stored in the indexed database. For example, an Italian Restaurant could subscribe to instances when a negative expression appears about the topic “cooking” and a positive expression appears about the topic “Italian food”. This could be expressed as: “(cooking)−(Italian food)+”. In the case that there is a blog page that contains, “I hate cooking . . . , but I love Italian food”, the Ad engine makes this match and delivers the Italian Restaurant's advertisement to that particular page. For each discovered match, advertisements are delivered to the pages that contain the match (See FIGS. 4-5).

An advertiser could subscribe to a single relationship of an expression-topic set such as (cooking)+. The advertiser's advertisement could then appear adjacent to content that contains positive expressions about cooking like “Cooking is Fun”, or “I like cooking”. An advertiser could also subscribe to place advertisements on websites in which “shoes” as a topic are described with an expression “uncomfortable”. Here the subscription could be (shoes, uncomfortable).

An advertiser would also be able to subscribe to a set of multiple topics and expressions. Advertiser's advertisement(s) will then be displayed adjacent to content which carries some or all elements of advertiser's subscription set. For example, if an advertiser subscribes to (shoes)+ and (hiking)+, the advertiser's advertisement will appear adjacent to content that either contains positive expressions about shoes, such as “I love shoes”, and/or positive expressions about hiking, such as “Hiking is fun”. This is particularly useful for a retailer of hiking shoes to place advertisements. A hiking shoe advertisement, in this example, will be delivered to pages where positive statements are made about shoes. The hiking shoe advertisement will also be delivered to pages where positive statements are made about hiking. Each of these separate instances provides a useful Ad placement for a hiking shoe retailer. If a blogger happens to express positive statements about shoes and hiking within the same blog, the usefulness of the Ad placement is further improved for the hiking shoe retailer. In general, an advertiser may create any number of advertisement subscriptions using similar steps as described above.

The following sections provide a detailed example of how digital available content is discovered, how ETs are identified, and how ETs are ranked for relevancy.

2. Pre-Processing

2.1. Web/Blog Page Identification

In a pre-processing step, target web pages and blog pages are identified on the Internet through the use of a web page discovery mechanism most commonly referred to as a web crawler. The web crawler starts at a blog page, stores the information on that blog page, and analyzes the information on the page to discover universal resource locator (URL) links to other user blog pages. The web crawler then visits all the blog pages linked to the original blog page and begins the process again. In a short time, the web crawler could be storing and analyzing tens of thousands to millions of blog pages at a time.

The web crawler sends each stored blog page to a staging table where it waits in queue for post-processing (section 2.2), polarity clue matching (section 2.3), expression analysis I (sections 2.4), and ET ranking (section 2.5). Variations and possible extensions of these methods are described in section 2.6, expression analysis II, and section 2.7, extensions of polarity categorization.

2.2 Post-Processing

2.2.1. Template Removal

The written entry of the blogger, referred to as content, is often surrounded on the web page by extraneous features such as advertisements, buttons, and graphics. The template removal process removes all these extraneous features so that only the blog content is sent for expression analysis. This could be accomplished by breaking the Web page into segments of continuous text. Using these segments, one could identify the actual content using the assumption that long segments are more likely to be the content whereas short and dispersed segments are the extraneous features of the web page. One could also take in account the distance of one segment to other segments that have already been classified.

2.2.2. Sentence Parsing

The content is then parsed into individual sentences. This could be done by identifying combinations of grammatical sentence break markers such as punctuation marks (for example periods, question marks and exclamation points) and capitalized letters. In one embodiment of the invention, several enhancements could be included to prevent the mis-categorization of sentences. A control, for example, could be put into place to identify the use of punctuation for other purposes than demarking the end of a sentence (such as for an abbreviation like “Mr.”). Another control could be put into place to control for capitalization of proper nouns. As person of average skill in the art would readily appreciate, a variety of such controls could be formulated using basic knowledge of the grammatical structure of sentences. These sentence controls could then be introduced to enhance the overall method.

2.2.3. Part of Speech

Once the content has been broken up into sentences, each sentence is analyzed to determine the part of speech of each word within the sentence. Each word is referenced to a look-up table that contains a list of words and their associated parts of speech. If a word has more than one part of speech associated with it, the words adjacent to the word in question are analyzed for their part of speech. A determination for a GERUND, for example, could be found by discovering a verb adjacent to the word in question. If a word is not found in the look-up table, the algorithm attempts to derive the word from base words in a dictionary. A heuristic approach could be used to identify whether a word is part of an entity, for example, “Jane Smith”, based on the location of the word in the sentence and the capitalization of the word.

As a person of average skill in the art would readily appreciate, the part of speech analysis could be further improved by applying additional part of speech identification controls that could be formulated using basic knowledge of the grammatical structure of sentences. These part of speech identification controls could then be introduced to enhance the overall method.

2.2.4. Sentence Structure

The sentence could be further analyzed to determine the structure of the sentence. In one example of such a sentence structure analysis, each sentence could be modeled as being made up of an independent clause that may be supported by a variety of dependent clauses. Each clause, in turn, could be supported by prepositional phrases. Prepositional phrases are identifiable by their base structure of e.g. PREPOSITION, ARTICLE, and/or NOUN. Independent and dependent clauses are made up of at least one NOUN and one VERB. Dependent clauses, however, are preceded by RELATIVE PRONOUNS, such as e.g. “when”, “where”, or “what”, or SUBORDINATE CONJUNCTIONS, such as e.g. “after”, “although”, and “because”. In this manner, each sentence could be broken up into independent clauses, dependent clauses, and prepositional phrases. SUBJECTS and OBJECTS could be identified based on various factors such as whether the VERB is active or passive.

As a person of average skill in the art would readily appreciate, an extensive lexicon of RELATIVE PRONOUNS and SUBORDINATE CONJUNCTIONS could be formulated using basic knowledge of the grammatical structure of sentences. A dependent clause analysis involving a comparison to a RELATIVE PRONOUNS and SUBORDINATE CONJUNCTIONS look-up table could then be introduced to enhance the overall method.

2.3. Polarity Clue Matching

Once the post-processing of the target content has been completed, the words within each clause and phrase could be referenced to a look-up table, which contains a list of polarity clues. In a preferred embodiment, polarity clues are words, e.g. ADJECTIVES, VERBS, and/or NOUNS that have been categorized into two or more (polarized) groups. For example, the polarity clues could be categorized into positive and negative word classes. Examples of words in the positive class are, for example, but not limited to: “great”, “love”, “like”, “want”, and “awesome”. Examples of words in the negative class are, for example, but not limited to: “horrible”, “hate”, “dislike”, and “disaster”. As a person of average skill in the art would readily appreciate, an extensive lexicon of positive and negative polarity clues could be constructed and would enhance the polarity clue look-up table.

2.4. Expression Analysis I

The expression analysis could begin once words within each clause and phrase have been matched with polarity clues. Clauses and phrases containing polarity clues are then categorized into expression classifications. In the case of positive and negative polarity classes, expressions could generally be classified into, but not limited to, three categories, such as for example:
1. Expression about the subject of the sentence:
   a. Jane Smith is a great actress!
   b. The film was a disappointment.
2. Expression about an object within the sentence:
   a. The children ate all the delicious cookies!
   b. We had a terrible lunch.
3. Expressions about the subject's attitude about something:
   a. I love my car!
   b. The audience hated the movie.
      2.4.1. Expression about the Subject of a Sentence

In example 1a “Jane Smith is a great actress”, the positive polarity clue, “great”, is identified as an ADJECTIVE in the clause “Jane Smith is a great actress!” Because the word “actress” has been identified as a NOUN, it is associated with the ADJECTIVAL polarity clue “great” due to the fact that the ADJECTIVAL polarity clue appears directly before a NOUN. Furthermore, the word “is” is identified as a LINKING VERB indicating that “actress” is the SUBJECT COMPLEMENT of the sentence and therefore is interchangeable with “Jane Smith”. Thus two ET sets have been identified in this exemplary sentence:
1. great—actress (expression—topic), positive polarity.
2. great—Jane Smith (expression—topic), positive polarity.

This exemplary expression framework could be applied to sentences varying from simple to complex as a person of average skill in the art would readily appreciate.

In example 1b “The film was a disappointment”, the negative polarity clue, “disappointment”, is identified as NOUN in the clause. Because the LINKING VERB “was” denotes a sentence form with a SUBJECT COMPLEMENT, the negative polarity clue “disappointment” is associated with the subject of the sentence “film”. Thus a single ET set is identified in this example:
1. disappointment—film (expression—topic), negative polarity.
   2.4.2. Expression about the Object within a Sentence

In example 2a “The children ate all the delicious cookies!”, the word “delicious” is identified as an ADJECTIVAL positive polarity clue. Because the identified clue precedes a noun, the polarity clue is associated with the topic “cookies”. Furthermore, the word “ate” is identified as an ACTION VERB denoting that there is no SUBJECT COMPLEMENT relationship between “cooking” and “children”. Thus one ET set is identified in this example:
1. delicious—cookies (expression—topic), positive polarity.

In example 2b “We had a terrible lunch”, the word “terrible” is identified as an ADJECTIVAL negative polarity clue. In similar fashion as described for example 2a, one ET set is identified in this sentence:
1. terrible—lunch (expression—topic), negative polarity.
   2.4.3. Expressions about the Subject's Attitude about Something

In example 3a “I love my car!”, the word “love” is identified as a VERB and as a positive polarity clue. Because the polarity clue has been identified as a VERB, it is determined that the expression relates to the subject's attitude towards the DIRECT OBJECT of the clause. In this case, the ET set identified is as follows:
1. love—car (expression—topic), positive polarity.

The process for identifying the ET set for example 3b, is similar in method to that described in 3a. The ET set in “The people hated the movie.” is identified as:
2. hated—movie (expression—topic), negative polarity.

Various forms and variations of these exemplary expression analyses could be applied to discover the ET relationships/sets as a person of average skill in the art would readily appreciate.

2.5. ET Ranking

For a given topic, multiple expression categories with multiple polarity clues could be identified in a corpus of blog pages or electronic documents. An example of such an identification is provided in the following example, which lists results for positive polarity instances of the topic “movie” that are stored in an indexed database.

| | | | Expression |
|---|---|---|---|
| Clause | ET Set | Polarity | about |
| I loved the movie | loved - movie | Positive | attitude |
| That movie was great | great - movie | Positive | subject |
| That was a great movie | great - movie | Positive | object |
| Everyone liked the movie | liked - movie | Positive | attitude |
| The movie was good | good - movie | Positive | subject |
| The movie was entertaining | entertaining - movie | Positive | subject |

In response to a user search query that may, for example, be displayed on a computer screen, consideration must be taken as to which order the indexed results should be displayed to the user. The following is an example of assigning a ranking to the lexicon of positive polarity clues based on the strength of the expression:

| Display Rank | Positive Polarity Clue |
|---|---|
| 1 | Loved |
| 2 | Great |
| 3 | Liked |
| 4 | Good |
| 5 | Entertaining |

Another example of assigning a ranking for an expression category could be developed as follows:

| Display Rank | Expression Category |
|---|---|
| 1 | Expression about attitude |
| 2 | Expression about subject |
| 3 | Expression about object |

Applying the polarity clue rank to the stored results for the topic “movie” and subsequently applying the expression category rank, the overall display rank could be determined such as:

| Overall Display Rank | Clause |
|---|---|
| 1 | I loved the movie |
| 2 | That movie was great |
| 3 | That was a great movie |
| 4 | Everyone liked the movie |
| 5 | The movie was good |
| 6 | The movie was entertaining |

As a person of average skill in the art would readily appreciate, the examples above could be extended to lexicons of polarity clues of any number and type, expression categories of any number and type, and polarity categories of any number and type.

It is also noted that the above proposed method for expression analysis and search query display ranking addresses clauses that may appear in independent or dependent forms within a sentence. As a person of average skill in the art would readily appreciate, other grammatical forms of language could be analyzed and used in the expression analysis and ranking. The following exemplary methods of e.g. disambiguation of polarity clues (section 2.6.1), negation analysis (section 2.6.2), comparative term analysis (section 2.6.3), and pronoun replacement (section 2.6.4) could be integrated to further enhance expression analyses for more complex or different types of sentence structures.

2.6. Expression Analysis II

2.6.1. Disambiguation of Polarity Clues

Polarity clues could result in a false positive ET identification if the polarity clues themselves are homographs. A homograph is defined as one of two or more words that have identical spellings but different meanings. Take for example, the polarity clue “like”. The word “like” can be a strong indicator of a positive expression about a topic, for example “I like reading”. The word “like” could also be used in a comparative sense such as in the clause “He looks like John”. In this instance, “like” is used as an ADJECTIVE, not a VERB. By analyzing the word preceding “like” in these instances, one can determine that the part of speech of “like” is an ADJECTIVE if it is not preceded by a NOUN or PRONOUN.

As a person of average skill in the art would readily appreciate, an extensive lexicon of homographs could be formulated using a basic knowledge of language and grammar. A disambiguation step involving comparison to a homograph look-up table could then enhance the overall method.

2.6.2. Negation Analysis

Polarity clues could be negated within a clause through use of distinct words, such as, for example “not” or “never”, or contractions, such as, for example “don't” or “wouldn't”. Take, for example, the following clauses:
I do not like coffee.
I wouldn't want the job.

By discovering the negation features “not” and “wouldn't” directly preceding the polarity clues “like” and “want”, one can then determine that the indicated polarity of the clue has been negated and has taken opposite form. The ET sets identified for these clauses could then be:

| Clause | ET Set | Negation Term | Polarity |
|---|---|---|---|
| I do not like coffee | like - movie | not | Negative |
| I wouldn't want the job | want - movie | wouldn't | Negative |

As a person of average skill in the art would readily appreciate, an extensive lexicon of negation terms could be formulated using a basic knowledge of the grammatical structure of sentences. A negation analysis step involving comparison to a negation term look-up table could then enhance the overall method.

2.6.3. Comparison Analysis

The relative strength of a polarity clue could also be reduced through the use of comparative text strings such as “more than” and “less than”, such as in the following examples:
I like coffee more than tea.
Children like vegetables less than candy.

In the first example, “I like coffee more than tea”, the polarity clue “like” indicates that the subject is expressing a positive affinity for “coffee” and “tea”. The use of the comparative string “more than” indicates a slightly less positive affinity for “tea” than “coffee”. The relative strength of the expression-topic set “like-tea” may then be reduced or set to zero relative strength when determining the display rank of the ET set in response to a user search query on a personal computer.

In the second example, “Children like vegetables less than candy”, the comparative term “less than” decreases the relative strength of the ET set “like-vegetables”. Numerically, the relative strength of the “like-vegetables” ET set may be reduced or set to zero strength when determining the display rank of the ET set.

As a person of average skill in the art would readily appreciate, an extensive lexicon of comparison terms could be formulated using a basic knowledge of the grammatical structure of sentences. A comparison analysis step involving comparison to a comparison term look-up table could then enhance the overall method.

2.6.4. PRONOUN Replacement

The use of simple PRONOUNS, such as, for example “he”, “she”, “it”, and “they”, could render the association of an expression to a topic impossible within a stand-alone clause, such as in the following example:
It was great.

The polarity clue “great” and the ET set “great-it” could be identified using the aforementioned method. The topic “it”, however, is of minimal practical utility to a user that queries a database of ET sets. The PRONOUN replacement method provides for a step after expression analysis in which ET sets with pronouns listed as the identified topic could be further analyzed to create an ET set with improved practical utility to a user query. Consider, for example, the clause that appears before “It was great”:
We went biking. It was great.

The relative PRONOUN “it”, in this case, can be associated to the object “biking” in the preceding sentence. Using the PRONOUN replacement method, “it” is replaced with “biking” and the ET set is improved from “great-it” to “great-biking”.

As a person of average skill in the art would readily appreciate, a complete lexicon of PRONOUNS could be formulated using a basic knowledge of the grammatical structure of sentences. A PRONOUN replacement step involving comparison to a PRONOUN replacement look-up table could then enhance the overall method.

2.7. Extensions of Polarity Categorization

So far, the discussion of the present method has focused on polarization/categorization of expressions into “positive” and “negative” categories. The method can be extended to include a variety of categories with two or more polarized ET sets or ET sets in general. The following sections provide examples on how categories can be further extended.

2.7.1. ADVERB Analysis

As mentioned earlier, the positive and negative polarity sets could be further subdivided into, for example, 4 sets categorized as “very positive”, “positive”, “negative”, and “very negative”. An example of a method to further categorize polarity sets could be to analyze the use of ADVERBS. The use of ADVERBS, for example “very” or “really”, could be used to distinguish gradients within the positive and negative polarity categories or to determine new polarity categories. For example:
The movie was great.
The movie was really great.

The second clause, “The movie was really great”, indicates a stronger positive expression than the clause, “The movie was great”, though both clauses are of general positive polarity. The use of ADVERB analysis could then be used to increase the number of polarized categories used to categorize ET sets.

As a person of average skill in the art would readily appreciate, a complete or more extensive lexicon of ADVERBS could be formulated using a basic knowledge of the grammatical structure of sentences. An ADVERB analysis step involving comparison to a ADVERB look-up table could then be used to increase the number of (polarized) categories.

2.7.2. State-of-Mind Analysis

The method as discussed so far is not limited to positive and negative polarity categorizations. For example, it would be possible to identify an author's state of mind such as in the following examples:
I am happy.
I am sad.
I am lonely.

A new polarity category set could then be assigned to ET sets of the form “good-I’ or “bad-I” that indicate the state of mind of the author. In fact, independent polarity categories could be created to cover the broad range of human states-of-mind. The advertiser subscription method above could then also be further enhanced by allowing an advertiser to specify the desired state-of-mind of the author for an ad placement.

As a person of average skill in the art would readily appreciate, a complete lexicon of state-of-mind expressions could be formulated with a basic knowledge of the human psyche. A state-of-mind analysis step involving comparison to a state-of-mind look-up table could then be used to increase the number of polarized categories and enhance an advertiser's ability to specify placement of their Ad.

3. Ranking of Advertisements

An expression-topic subscription could be ranked to determine advertisement placement. This is particularly relevant when multiple advertisers subscribe to the same expression-topic set. Ranking advertisement placement could be done in a variety of ways or combinations thereof, such as, for example:
One could count the relative number of occurrences of expression-topic combinations. For example, if the target content page refers positively to “cooking” multiple times and positively to “Italian food” only once, then the number of occurrences can be used to preferentially rank (cooking)+ advertisements over (Italian food)+ advertisements on the aforementioned target page (Table 2 and 4).
One could also determine the placement of advertisements through a competitive bidding process by advertisers for each expression-topic subscription (Table 3 and 5). The bid price can be based on cost-per-click (cpc), cost-per-action (cpa), cost-per-1000 impressions (cpm), or any other cost basis.
One could use the historical click-through-rate of an advertisement once it is displayed.
One could calculate a match-score for the advertiser's subscription set to the target content.

To illustrate these ranking methods to determine the ranks for two or more competing subscription sets, consider a set of two advertisers that have the following respective subscription sets: Advertiser1 {shoes+, skating+, outdoors+} and Advertiser2 {shoes+, hiking+, outdoors+}. Also consider, for example, the expression analysis results of an exemplary page of blog content as shown in Table 2.

TABLE 2
An example of expression analysis
output for hypothetical blog page

| Analyzed Content - Expressions | # Occurrences |
|---|---|
| Shoes+ | 2 |
| Hiking+ | 1 |
| Outdoors+ | 1 |
| . . . (Other ET's) | 20 |
| Total # opinions in target content | 24 |

The bidding results for Advertiser1 and Advertiser2 for the specific ET sets could be as shown in Table 3.

TABLE 3
An example of subscription sets of competing advertisers.

| Advertiser1 | Bid | Advertiser2 | Bid |
|---|---|---|---|
| Subscription Set | Price | Subscription Set | Price |
| Shoes+ | $0.03 | Shoes+ | $0.04 |
| Skating+ | $0.05 | Hiking+ | $0.10 |
| Outdoors+ | $0.06 | Outdoors+ | $0.03 |

First, one could calculate a proposed “OccurrenceRank” for each subscription set as shown in Table 4.

TABLE 4
An example of ranking subscription sets of competing
advertisers based on number of occurrences.

| | # Occurrences | | # Occurrences |
|---|---|---|---|
| Advertiser1 | in Target | Advertiser2 | in Target |
| Subscription Set | Content | Subscription Set | Content |
| Shoes+ | 2 | Shoes+ | 2 |
| Skating+ | 0 | Hiking+ | 1 |
| Outdoors+ | 1 | Outdoors+ | 1 |
| OccurrenceRank1 | 3 | OccurrenceRank2 | 4 |

According to the OccurrenceRank calculation, Advertiser2 would receive preferential placement based on its higher OccurrenceRank score relative to its subscription set.

As a person of average skill in the art would readily appreciate, the probability of a tie OccurrenceRank score could be relatively high based on overlap between competing subscription sets. A variation to this method would be to calculate an additional ranking based on the bid price of each ET element with each subscription set. This rank could be described as a BidRank. The BidRank could be calculated for the example above as shown in Table 5.

TABLE 5
An example of ranking subscription sets of competing advertisers
based on bid price based on a sum of bid prices.

| Advertiser1 | Bid | Advertiser2 | Bid |
|---|---|---|---|
| Subscription Set | Price | Subscription Set | Price |
| Shoes+ | $0.03 | Shoes+ | $0.04 |
| | | Hiking+ | $0.10 |
| Outdoors+ | $0.06 | Outdoors+ | $0.03 |
| BidRank1 (sum) | $0.09 | BidRank2 (sum) | $0.17 |

In the case of Advertiser1's subscription set, the ET set (skating)+ did not appear in the target content so it has been removed from the BidRank calculation for Advertiser1 relative to the blog content used in this example.

To further improve the Ad ranking method, the OccurrenceRank and BidRank scores could be combined to form an intermediate ranking measure:
OBRank1=(3 occurrences/24 total opinions)×$0.09=0.011
OBRank2=(4 occurrences/24 total opinions)×$0.17=0.028

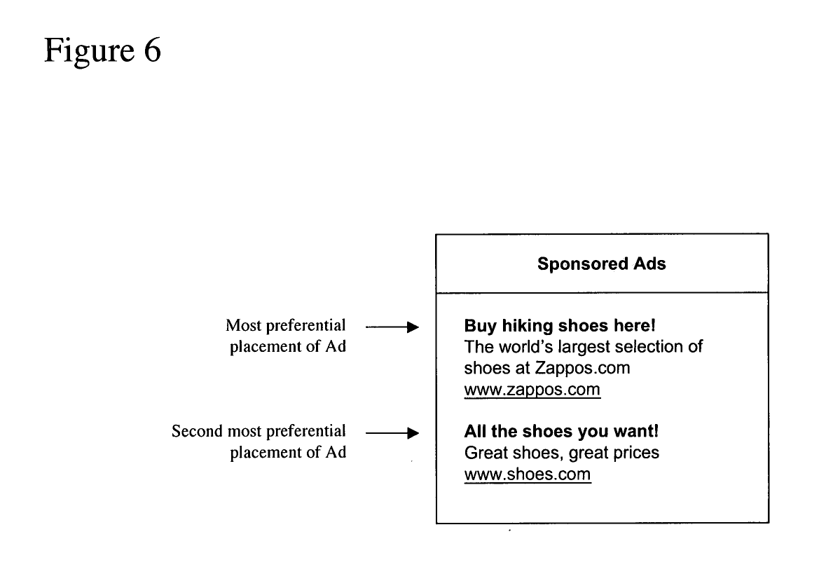

In this example, Advertiser2 would receive preferential Ad placement for the target content. Advertiser1's advertisement may also be placed adjacent to the content, but in a less preferential position (See also FIG. 6).

Once sufficient pageviews have been registered for each advertisement, the rankscore could be further improved by calculating the total number of clicks the advertisement has historically registered. For example, if both Advertiser1 and Advertiser2 ads have been viewed 1000 times each have been clicked on 300 and 100 times, respectively, then an improved rankscore can be calculated as:
Rankscore1′=0.011×(300 clicks/1000 pageviews)=0.00338
Rankscore2′=0.028×(100 clicks/1000 pageviews)=0.00283

The improved rankscore results in Advertiser1 being awarded preferential Ad placement after sufficient click-through data has been gathered.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, even though the examples have been for digitally available content, the invention could also be useful for traditional forms of published content. Examples of traditional forms of printed content include, for example, magazines, newspapers, reviews, journals, editorials, or the like. Another variation includes the type of advertisement an advertiser can chooses to display. The advertisement may be composed of text, graphics, audio, rich media or any combination therein. Another variation relates to including psychographic traits, such as interests, tastes, hobbies, opinions, and habits, as well as demographic information, could be used to include in the expression-topic analysis as well as in the categorization of the groups. All such variations are considered to be within the scope and spirit of the present invention as defined by the following claims and their legal equivalents.

What is claimed is:

1. A method for displaying advertisements on a digitally available page, comprising:
(a) identifying expressions about topics in digitally available content;
(b) categorizing expression-topic sets into at least two distinct groups;
(c) associating at least one advertisement to at least one of said expression-topic sets selected from said categorized groups; and
(d) displaying said at least one associated advertisement on the digitally available page containing at least part of said at least one associated expression-topic set.

2. The method as set forth in claim 1, wherein said digitally available content comprises content available in a blogosphere, in instant messengers, in emails, in periodicals, in magazines, in newspapers, in reviews, in journals or in editorials.

3. The method as set forth in claim 1, wherein said expressions about topics are sentiments about topics, opinions about topics, perceptions about topics, feelings about topics, moods about topics, expressions about author's state of mind, or any combination thereof.

4. The method as set forth in claim 1, wherein said at least two distinct groups are polarized groups.

5. The method as set forth in claim 1, further comprising ranking said categorized expression-topic sets.

6. The method as set forth in claim 1, further comprising searching said categorized expression-topic sets for expressions about a topic of interest.

7. The method as set forth in claim 1, further comprising subscribing said at least one advertisement to said at least one of said categorized expression-topic sets.

8. The method as set forth in claim 1, further comprising ranking said associated expression-topic sets to determine placement of said associated advertisements on said digitally available page.

9. The method as set forth in claim 1, further comprises bidding on said at least one of associated expression-topic sets to determine placement of said associated advertisements on said digitally available page.

10. A method for searching expressions about topics, comprising:
(a) identifying said expressions about said topics in digitally available content;
(b) categorizing expression-topic sets into at least two distinct groups;
(c) searching said categorized expression-topic sets for expressions about a topic of interest; and
(d) displaying the search results for said topic of interest, wherein said displaying comprises organizing said identified expression-topic sets for said topic of interest into said at least one distinct group.

11. The method as set forth in claim 10, wherein said digitally available content comprises content available in a blogosphere, in instant messengers, in emails, in periodicals, in magazines, in newspapers, in reviews, in journals or in editorials.

12. The method as set forth in claim 10, wherein said expressions about topics are sentiments about topics, opinions about topics, perceptions about topics, feelings about topics, moods about topics, expressions about author's state of mind, or any combination thereof.

13. The method as set forth in claim 10, wherein said organizing said identified expression-topic sets for said topic of interest is into said at least two distinct groups.

14. The method as set forth in claim 10, wherein said at least one distinct groups is a polarized group.

15. The method as set forth in claim 10, further comprising ranking said categorized expression-topic sets.

16. The method as set forth in claim 10, further comprising ranking said expression-topic sets in said search results.

17. The method as set forth in claim 10, further comprising associating at least one advertisement to at least one of said expression-topic sets in said search results.

18. The method as set forth in claim 17, further comprising displaying said at least one associated advertisement on the digitally available page containing at least part of said at least one associated expression-topic set.

19. The method as set forth in claim 10, further comprising subscribing at least one advertisement to at least one of said expression-topic sets in said search results.

20. The method as set forth in claim 19, further comprising displaying said at least one subscribed advertisement on the digitally available page containing at least part of said at least one associated expression-topic set.
